(19) United States
(12) Patent Application Publication
(10) Pub. No.: US 2026/0134270 A1
(43) Pub. Date: May 14, 2026

(54) QUANTIZATION OF WEIGHTS IN A NEURAL NETWORK BASED COMPRESSION SCHEME

(71) Applicant: InterDigital CE Patent Holdings, SAS, Paris (FR)

(72) Inventors: Bharath Bhushan Damodaran, Vannes (FR); Muhammet Balcilar, Betton (FR); Pierre Hellier, Thorigne-Fouillard (FR); Francois Schnitzler, Saint Avé (FR)

(21) Appl. No.: 19/118,678

(22) PCT Filed: Sep. 27, 2023
(86) PCT No.: PCT/EP2023/076733

§ 371 Date: Apr. 4, 2025

(30) Foreign Application Priority Data
Oct. 4, 2022 (EP) 22306480.9

(51) Int. Cl. G06N 3/0495; G06N 3/0455; G06V 10/82

(52) U.S. Cl. CPC G06N 3/0495; G06N 3/0455; G06V 10/82

(57) ABSTRACT

An encoding method is disclosed. Weights of a neural network are first obtained that are representative of an input image. At least one value representative of a maximum absolute value of weights in a layer of said neural network is then obtained. The weights of said layer are quantized responsive to said at least one value. The at least one value and the quantized weights are finally encoded in a bitstream. These encoded weights may be provided to a decoder configured to reconstruct an image.

### CROSS REFERENCE TO RELATED APPLICATIONS

This application claims the benefit of European Application No. 22306480.9, filed on Oct. 4, 2022, which is incorporated herein by reference in its entirety.

### TECHNICAL FIELD

At least one of the present embodiments generally relates to a method and an apparatus for encoding (respectively decoding) weights of a neural network, said weights being representative of an image.

### BACKGROUND

Image and video compression is a fundamental task in image processing, which has become crucial in the time of pandemic and increasing video streaming. Thanks to the community's huge efforts for decades, traditional methods have reached current state of the art rate-distortion performance and dominate current industrial codecs solutions. End-to-end trainable deep models have recently emerged as an alternative, with promising results. They now beat the best traditional compressing method (VVC, versatile video coding) even in terms of peak signal-to-noise ratio for single image compression.

### SUMMARY

In one embodiment, an encoding method is disclosed that comprises:
obtaining weights of a neural network, said weights being representative of an input image; obtaining at least one value representative of a maximum absolute value of weights in a layer of said neural network;
quantizing the weights of said layer responsive to said at least one value; and
encoding said at least one value and the quantized weights in a bitstream.

An encoding apparatus is disclosed that comprises one or more processors and at least one memory coupled to said one or more processors, wherein said one or more processors are configured to perform the method disclosed just above.

In another embodiment, a decoding method is disclosed that comprises:
obtaining a bitstream comprising at least one value representative of a maximum absolute value of weights in a layer of a neural network and quantized weights of said layer;
decoding said at least one value and said quantized weights of a neural network from the bitstream;
inverse quantizing the quantized weights of said layer responsive to the at least one value to obtain dequantized weights; and
reconstructing an image using a neural network parametrized by the dequantized weights.

A decoding apparatus is disclosed that comprises one or more processors and at least one memory coupled to said one or more processors, wherein said one or more processors are configured to perform the method disclosed above.

Further embodiments that can be used alone or in combination are described herein.

One or more embodiments also provide a computer program comprising instructions which when executed by one or more processors cause the one or more processors to perform the method for encoding/decoding image or video data according to any of the embodiments described herein. One or more of the present embodiments also provide a non-transitory computer readable medium and/or a computer readable storage medium having stored thereon instructions for encoding/decoding image or video data according to the methods described herein.

One or more embodiments also provide a computer readable storage medium having stored thereon encoded data, e.g. a bitstream, generated according to the methods described herein.

One or more embodiments also provide a method and apparatus for transmitting or receiving encoded data, e.g. a bitstream, generated according to the methods described above.

### BRIEF DESCRIPTION OF THE DRAWINGS

FIG. 1 illustrates a block diagram of a system within which aspects of the present embodiments may be implemented;

FIG. 2 illustrates an example of end-to-end neural network based compression system 200 for encoding an image using a deep neural network;

FIG. 3 illustrates an example of an end-to-end implicit neural network based compression system for encoding an image;

FIG. 4 illustrates an example of flowchart of a method for encoding according to an embodiment;

FIG. 5 illustrates an example of an image decoder according to at least one embodiment;

FIG. 6 illustrates an example of flowchart of a method for decoding according to an embodiment;

FIG. 7 illustrates a method for training of the INR that is made aware of the quantization according to an embodiment;

FIG. 8 illustrates an example of flowchart of a method for encoding according to an embodiment;

FIG. 9 illustrates a model to be used for entropy encoding according to an embodiment;

FIG. 10 illustrates an example of an image decoder according to at least one embodiment;

FIG. 11 illustrates an example of flowchart of a method for decoding according to an embodiment; and

FIGS. 12-14 illustrate experimental results of obtained with a method according to at least one embodiment.

### DETAILED DESCRIPTION

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

The aspects described and contemplated in this application can be implemented in many different forms. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “encoded” or “coded” may be used interchangeably, the terms “pixel” and “sample” may be used interchangeably and the terms “image,” “picture” and “frame” may be used interchangeably. Usually, but not necessarily, the term “reconstructed” is used at the encoder side while “decoded” is used at the decoder side.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

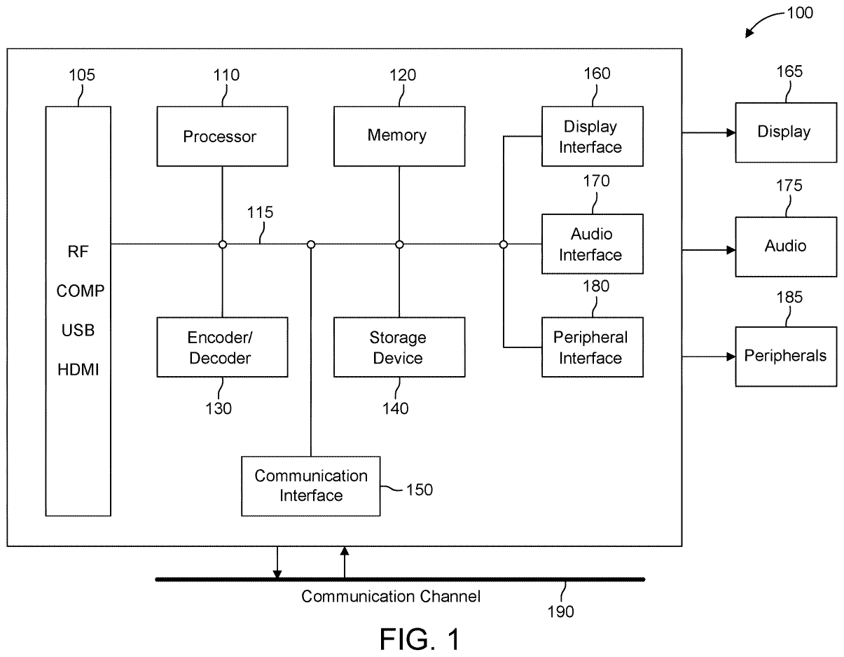

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder module 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In some embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations.

The input to the elements of system 100 may be provided through various input devices as indicated in block 105. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1, include composite video.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder module 130 operating in combination with the memory and storage elements to process the datastream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11 (IEEE refers to the Institute of Electrical and Electronics Engineers). The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105. As indicated above, various embodiments provide data in a non-streaming manner. Additionally, various embodiments use wireless networks other than Wi-Fi, for example a cellular network or a Bluetooth network.

The system 100 may provide an output signal to various output devices, including a display 165, speakers 175, and other peripheral devices 185. The display 165 of various embodiments includes one or more of, for example, a touchscreen display, an organic light-emitting diode (OLED) display, a curved display, and/or a foldable display. The display 165 can be for a television, a tablet, a laptop, a cell phone (mobile phone), or other device. The display 165 can also be integrated with other components (for example, as in a smart phone), or separate (for example, an external monitor for a laptop). The other peripheral devices 185 include, in various examples of embodiments, one or more of a stand-alone digital video disc (or digital versatile disc) (DVR, for both terms), a disk player, a stereo system, and/or a lighting system. Various embodiments use one or more peripheral devices 185 that provide a function based on the output of the system 100. For example, a disk player performs the function of playing the output of the system 100.

In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

The embodiments can be carried out by computer software implemented by the processor 110 or by hardware, or by a combination of hardware and software. As a non-limiting example, the embodiments can be implemented by one or more integrated circuits. The memory 120 can be of any type appropriate to the technical environment and can be implemented using any appropriate data storage technology, such as optical memory devices, magnetic memory devices, semiconductor-based memory devices, fixed memory, and removable memory, as non-limiting examples. The processor 110 can be of any type appropriate to the technical environment, and can encompass one or more of microprocessors, general purpose computers, special purpose computers, and processors based on a multi-core architecture, as non-limiting examples.

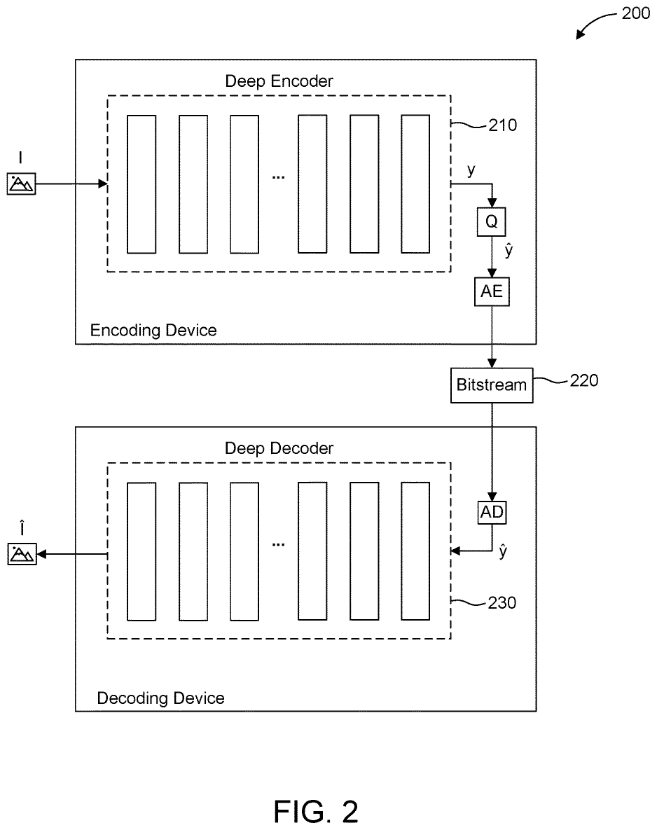

FIG. 2 illustrates an example of end-to-end neural network based compression system 200 for encoding an image using a deep neural network. An input image to be encoded, I, is first processed by a deep neural network encoder 210 (hereafter identified as deep encoder). The output of the encoder, y, is called the embedding of the image. This embedding is encoded, e.g. into a bitstream 220, by going through a quantizer Q, and then through an entropy encoder, e.g. an arithmetic encoder AE. The resulting bitstream 220 is decoded by going through an entropy decoder, e.g. an arithmetic decoder AD, to reconstruct the quantized embedding ŷ. The reconstructed quantized embedding can be processed by a deep neural network decoder 230 (hereafter identified as deep decoder or decoder) to obtain the decompressed image Î.

The deep encoder and decoder are composed of multiple neural layers, such as convolutional layers. Each neural layer can be described as a function that first multiplies the input by a tensor, adds a vector called the bias and then applies a nonlinear function on the resulting values. The values of the tensor and the bias are denoted by the term “weights”. The weights and, if applicable, the parameters of the non-linear functions, are called the parameters of the network. In such a compression system, the encoder and decoder are fixed, based on a predetermined model supposed to be known when encoding and decoding. The encoder and the decoder neural networks are for example trained simultaneously so that they are compatible. Indeed, to learn the weights of the encoder and decoder, the neural network is trained on massive databases D of images. Together, they are sometimes called an “autoencoder” that encodes an input and then reconstructs it. The architecture of the decoder is typically mostly the reverse of the encoder, although some layers or their ordering can be slightly different.

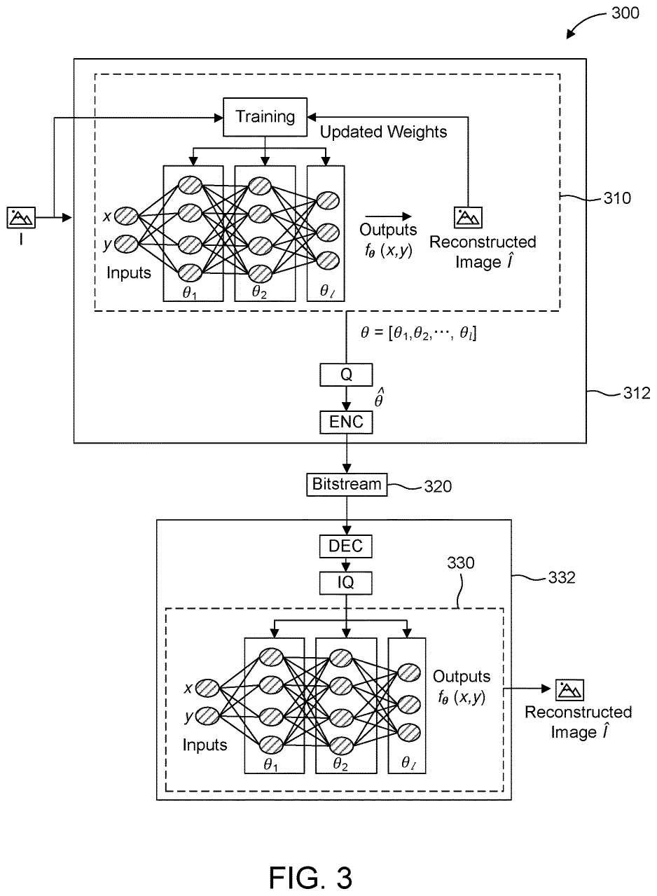

FIG. 3 illustrates an example of an end-to-end implicit neural network (INR) based compression system 300 for encoding an image. The system comprises an encoder 312 generating encoded data, e.g. in the form of a bitstream 320, and a decoder 332. The encoder 312 comprises an INR 310 and the decoder 332 comprises an INR 330. Compared to an autoencoder based image compression, which uses latent points to control a rate-distortion objective, in an INR based compression system, the rate (R)-distortion (D) trade-off is controlled by the number of weights or size of the neural network. So, for different rates, the INR has a different neural network architecture with different number of weights. As illustrated on FIG. 3, the INR 310 or 330 maps pixel co-ordinates (x,y) to pixel values, e.g. (R, G, B) values, or other values such as YCbCr, YUV or any other color values of a given color space, e.g. ƒ_{θ}(x,y)=(r, g, b) in the case where RGB color space is considered, where ƒ_{θ}( ) is an INR function. The INR is designed using multi-layer perceptron (MLP) with ‘L’ being a number of layers each comprising desired number of hidden neurons. Each layer can be described as a function that first multiplies the input values by a tensor, adds a bias, and finally transforms the result by a non-linear activation function. The values of the tensor and the bias are denoted by the term “weights” and are denoted θ. These weights are unknown and are to be estimated on the encoder side.

Compressing an image I using the INR function ƒ_{θ} is equivalent to determining these weights for storage or transmission. To this aim, the image I is first processed by the INR 310 which is responsible for determining weights θ from the image I. The weights θ are encoded, e.g. into a bitstream 320, by going through a quantizer Q, and then through an encoder ENC, e.g. an entropy encoder such as an arithmetic encoder. The resulting bitstream is decoded by going through a decoder DEC to reconstruct quantized weights which are dequantized by an inverse quantizer IQ (a.k.a a de-quantizer). The pixel coordinates of the image to be reconstructed are then inputted into the INR 330 parametrized by the dequantized weights to obtain a reconstructed image Î.

As opposed to autoencoders, the weights θ may be determined by learning on the image I to be encoded. Consequently, each image to be encoded has its own associated weights. The weights θ may be determined by minimizing the following loss function:

$$Loss = \frac{1}{MN} {\sum }_{x , y} d ( I ( x , y ) , {f}_{θ} ( x , y ) ) \qquad ( 1 )$$

In equation (1), the sum is over all the pixels of coordinates (x,y) in the image of size M×N, d is a distortion which measures the similarity between the reconstructed pixel values, also called predicted pixel values, denoted by ƒ_{θ}(x,y), and the actual pixel values of the image I, denoted by I(x,y). Thus, d could be any differentiable distortion measure, such as mean squared error. Perceptual metrics such as LPIPS (learned perceptual image patch similarity) may also be used. In this case, the loss is the mean squared error between the neural network's activation. The weights θ may be determined through a batch gradient descent method or a stochastic gradient descent method. The non-linear activation functions used in the INR plays a crucial role in overfitting the high frequency signals in the underlying image. Sinusoidal activation functions may be used to capture high frequency details and better overfit the image I.

For each image I, there is one specific INR function ƒ_{θ} which is overfitted to the given image I. The quality of the reconstructed image by ƒ_{θ} depends on the size of the neural network. As the weights are used as descriptors of the image, the larger the size of the neural network the higher the bitlength. On the other hand, constraining the number of weights will decrease the bitlength at the expense of the distortion.

Some existing methods for quantizing the weights perform naive quantization of the weights by quantizing 32-bit precision weights to 16-bit precision weights. Post-training quantization or primitive quantization aware training methods may also be used. However, the compression efficiency of these methods is not optimal, since the INR is not aware of the distortions coming from the post-training quantization's or quantization method and entropy model is not efficient in existing quantization aware training procedures.

Embodiments described hereafter aims at improving the quantization and possibly the entropy encoding to increase the compression efficiency, i.e. reduce the file size of weights with negligible or minimal loss of the reconstruction quality. The principle may also apply to the encoding/decoding of an image (i.e. frame) of a video sequence. Besides, the decoding methods disclosed hereafter make it possible to progressively decode the image, e.g. by decoding parts of the image or a low resolution image first, simply by evaluating the function ƒ_{θ} at various pixel locations, e.g. one out of two pixels. Partially decoding images is difficult with an autoencoder.

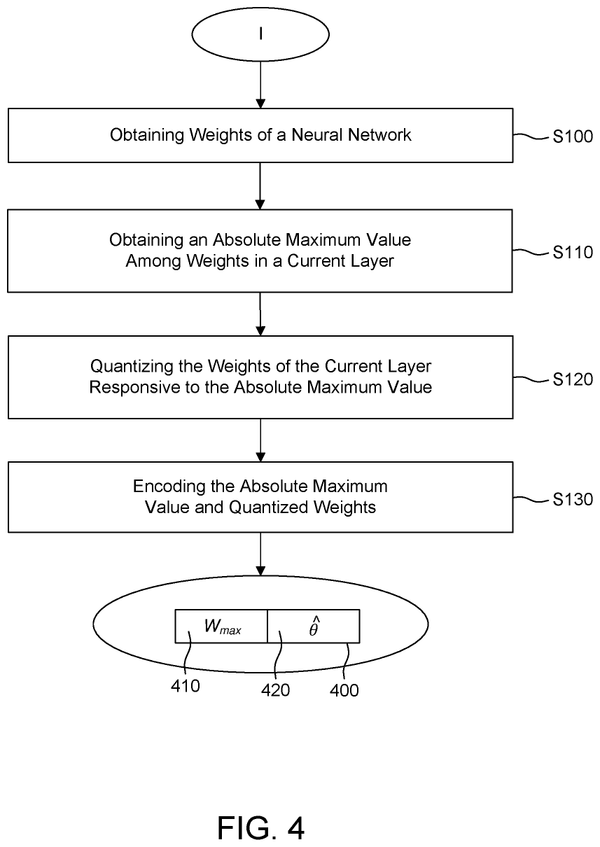

FIG. 4 illustrates an example of flowchart of a method for encoding an image I according to an embodiment. This method may be operated by the encoder 312 of FIG. 3 and for example implemented in the system 100 of FIG. 1. Let θ_{w}=[θ_{w}_{¹}, θ_{w}_{²}, . . . , θ_{w}_{^{L}}] be a collection of tensor values, and θ_{b}=[θ_{b}_{¹}, θ_{b}_{²}, . . . , θ_{b}_{^{L}}] be a collection bias of all the layers with full precision, and θ=[θ_{w}, θ_{b}]. These weights may be obtained at step S100 by training the neural network with full precision (e.g. 32-bit floating point weights) by minimizing the loss function of Equation (1).

In a step S110, a maximum absolute value among a type of weights, e.g. among the tensor values or among the bias, in a current layer of index l is obtained. The maximum absolute value is computed over this type of weights (e.g. for the tensor values) as follows:

$${w}_{max}^{l} = max ( \vert {θ}_{{w}^{l}} \vert )$$

In a step S120, the weights in the current layer are quantized responsive to the obtained maximum absolute value to obtain quantized weights. Quantizing the weights comprises dividing the weights by the obtained maximum absolute value to obtain normalized weights as follows:

$${θ}_{{nw}^{l}} = \frac{{θ}_{{w}^{l}}}{{w}_{max}^{l}}$$

The normalized weights are then quantized using a fixed-bit quantizer. Let q be a number of fixed bits used to quantize the weights. In an example, q=8 for 8-bit quantization, an

$$k = \frac{{2}^{q}}{2} - 1.$$

The quantized weights are obtained as follows:

$$Q ( {θ}_{{w}^{l}} ) = {\hat{θ}}_{{w}^{l}} = round ( {θ}_{{nw}^{l}} \cdot k )$$

Said otherwise, the quantized weights are directly obtained as follows:

$$Q ( {θ}_{{w}^{l}} ) = {\hat{θ}}_{{w}^{l}} = round ( \frac{{θ}_{{w}^{l}}}{max ( \vert {θ}_{{w}^{l}} \vert )} \cdot k )$$

The number of fixed bit (q) may be the same for an entire dataset. In a variant, the value of q may be chosen according to any incoming image to be encoded and may thus vary per image. In this case, the value of q may be encoded in the bitstream and thus decoded on the decoder side.

In a step S130, the maximum absolute value

$${w}_{m ax}^{l}$$

is encoded using n bits, e.g. n=16 bits, and the quantized weights \hat{θ}_{w}_{^{l}} are encoded for example in a bitstream 400 that may be stored on a storage medium or transmitted to another device, e.g. to a decoder. The quantized weights may be directly written in the bitstream using q bits. In a variant, the quantized weights may be entropy encoded, e.g. using an arithmetic encoder. The person skilled in the art will understand that the elements 410 (encoded maximum absolute value(s)) and 420 (encoded quantized weights) in the bitstream 400 may be arranged in any order or even interleaved in a bitstream. In an example, the above steps S110 to S130 may be repeated for another layer. In an example, the above steps S110 to S130 are repeated for all remaining layers and the fixed-bit quantized weights of all the layers are denoted as \hat{θ}_{w}=[\hat{θ}_{w}_{¹}, . . . , \hat{θ}_{w}_{^{L}}]. Encoding the maximum absolute value of weights for all layers costs L×n bits in addition to the fixed-bit quantized weights. In a similar manner, the above steps S110 to S130 may be repeated for the quantization and encoding of another type of weights, e.g. the bias, of one current layer or more than one layer, e.g. for all layers. The quantized bias for layer l are denoted \hat{θ}_{b}_{^{l}} and the maximum absolute value is denoted

$${b}_{max}^{l} .$$

The fixed-bit quantized bias of all the layers are denoted as \hat{θ}_{b}=[\hat{θ}_{b}_{¹}, . . . , \hat{θ}_{b}_{^{L}}].

Encoding the maximum absolute value of tensor and bias for the current layer costs 2×L×n bits in addition to the network weights. In this case,

$${w}_{ma x} = [ {w}_{m ax}^{1} , … , {w}_{ma x}^{L} , {b}_{m ax}^{1} , … , {b}_{ma x}^{L} ]$$

In one example, only a subset of the weights may be quantized, e.g., only the biases, only the tensor values and/or only some layers. In this case, only a subset of the maximum absolute values are thus signaled in the bitstream, e.g. only

$$[ {b}_{m ax}^{1} , … , {b}_{ma x}^{L} ] .$$

In one example, the above quantization may be performed at once on all quantized weights rather than in an iterative process over layers.

Rather than layer by layer, the aforementioned iterative process may be performed over any subsets of weights, e.g., weight by weight, neuron by neuron, groups of neurons by groups of neurons or any combination of these subsets, including e.g., quantizing some weights of some/all layers at each iteration.

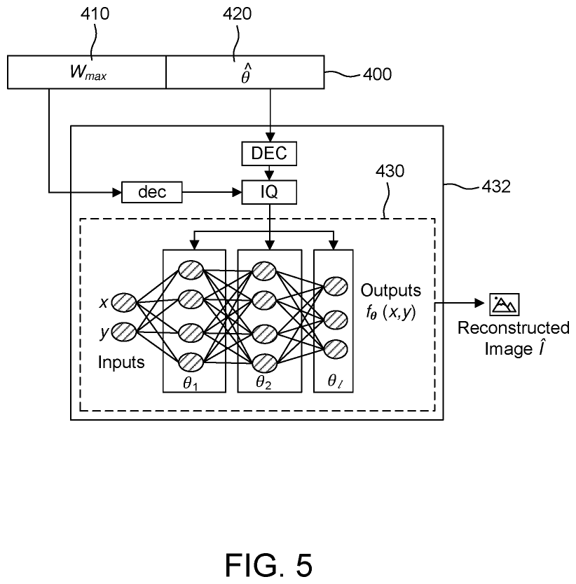

FIG. 5 illustrates an example of an image decoder 432 according to at least one embodiment. This image decoder 432 is for example implemented in the system 100 of FIG. 1 and is adapted to decode encoded data, for example arranged as a bitstream 400, comprising encoded maximum absolute value(s) 410 and encoded quantized weights 420. The encoded maximum absolute value(s) 410 is decoded dec from the bitstream. The encoded quantized weights 420 are decoded DEC and inverse quantized (also called dequantized) responsive to the decoded maximum absolute value(s). The pixel coordinates of the image to be reconstructed are then inputted into the INR 430 parametrized by the dequantized weights to obtain a reconstructed image Î.

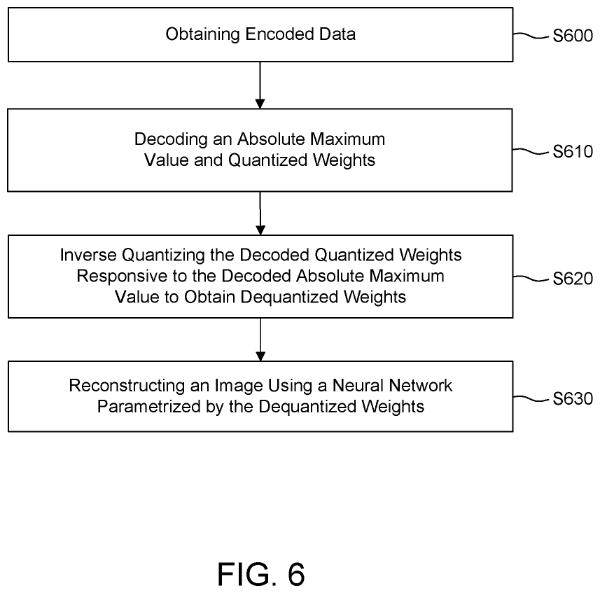

FIG. 6 illustrates an example of flowchart of a method for decoding according to an embodiment. This method may be operated by the decoder 332 of FIG. 3 or the decoder 432 of FIG. 5 and for example implemented in the system 100 of FIG. 1.

In a step S600, the decoder obtains encoded data, e.g. in the form of a bitstream, received from another device or read from a storage medium. The encoded data, e.g. the bitstream 400, comprises at least one maximum absolute value(s) wₘₐₓ 410 and the quantized weights \hat{θ} 420 for example as depicted on FIG. 5.

In a step S610, quantized weights \hat{θ} and at least one maximum value wₘₐₓ are decoded from the bitstream. This step is the inverse of the step S130 on the encoder side. Therefore, in the case where the quantized weights were entropy encoded, they are entropy decoded at S610.

In a step S620, the decoded quantized weights are inverse quantized. As an example, for a current layer l and for a tensor value, the dequantized weight is obtained as follows:

$${Q}^{- 1} ( {\hat{θ}}_{{w}^{l}} ) = \frac{{\hat{θ}}_{{w}^{l}}}{k} {w}_{m ax}^{l} .$$

The same principle may apply to all layers and all types of weights, e.g. the bias, or a subset of them depending on what was encoded.

In a step S630, the pixel coordinates of the image to be reconstructed are then inputted into the INR 330 parametrized by the dequantized weights to obtain the reconstructed image Î.

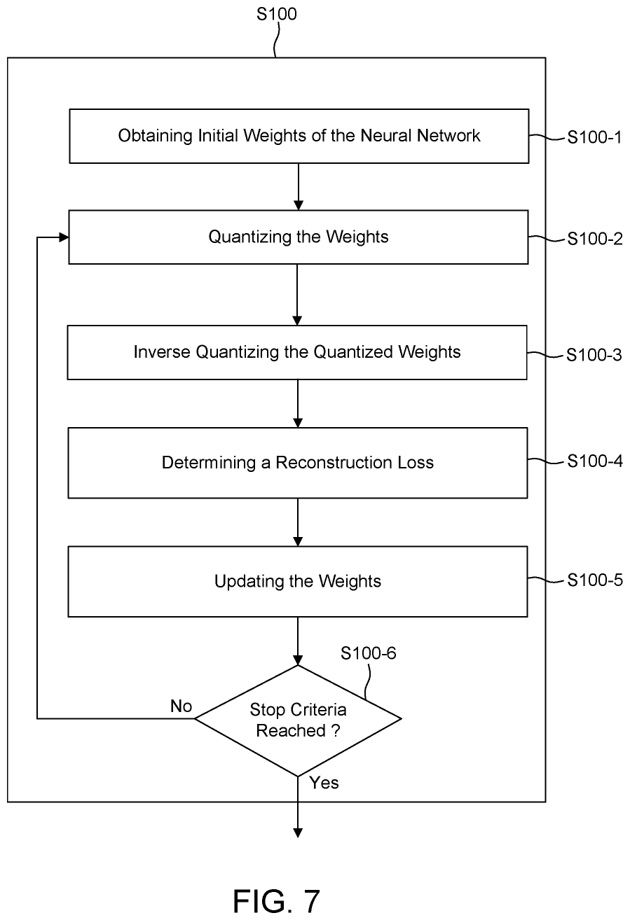

FIG. 7 illustrates a method for training of the INR that is made aware of the quantization according to an embodiment. This method may be used to obtain, at the step S100, the weights to be encoded.

Quantization aware training may start from already trained model's weights θ* with full precision (e.g. 32-bit floating point weights). Said otherwise, initial weights are obtained at a step S100-1, e.g. weights θ*. In a variant, default random initialization of weights may be obtained instead.

In a step S100-2, these weights are quantized into quantized weights \hat{θ} by applying the steps S110 to S120 of the method of FIG. 4

$$( i . e . {\hat{θ}}_{{x}^{l}} = round ( \frac{{θ}_{{x}^{l}}}{max ( \vert {θ}_{{x}^{l}} \vert )} \cdot k )$$

with x=w or x=b and are used as initial values of the parameters.

In a step S100-3, the quantized weights are dequantized as follows:

$${Q}^{- 1} ( {\hat{θ}}_{{x}^{l}} ) = \frac{{\hat{θ}}_{{x}^{l}}}{k} {x}_{m ax}^{l}$$

The dequantized weights are denoted as θ̆.

In a step S100-4, a reconstruction loss is computed as follows:

$$Loss = \frac{1}{MN} {\sum }_{x , y} d ( I ( x , y ) , {f}_{{θ}^{︶}} ( x , y ) ) \qquad ( 2 )$$

This loss function is defined from a distortion d( ) between ƒ_{θ̆}(x,y), called quantized model's prediction, i.e. an image reconstructed from the neural network INR parametrized with dequantized weights θ̆, and the original input image I.

In a step S100-5, the weights are updated responsive to reconstruction loss using a batch gradient descent method or a stochastic gradient descent method.

These steps S100-2 to S100-5 are repeated until a stop criteria is reached S100-6. The stop criteria may be a convergence criteria (e.g. Loss<threshold value) or a certain number K of iterations is reached, e.g. K=10000.

In a first variant, the quantization aware-training based on a loss function defined from a distortion between quantized model's prediction ƒ_{θ̆}(x,y) and original input image I is modified to include a regulation term T with a hyperparameter λ. Thus, during the training, the following loss function is minimized instead of the loss of equation (2):

$$Loss = \frac{1}{M N} {\sum }_{x , y} d ( I ( x , y ) , {f}_{{θ}^{︶}} ( x , y ) ) + λ T \qquad ( 3 )$$

The regularization term T may have various definition.

In a first example, T is the distortion between the quantized model's prediction ƒ_{θ̆}(x,y) and fixed (throughout the training) full-precision model's prediction ƒ_{θ*}(x,y)=. Said otherwise, T is the distortion between an image reconstructed from the neural network INR parametrized with dequantized weights θ̆ and an image reconstructed from the neural network INR parametrized with full-precision weights θ*. Thus, during the training, the following loss function is minimized:

$$Loss = \frac{1}{M N} {\sum }_{x , y} d ( I ( x , y ) , {f}_{{θ}^{︶}} ( x , y ) ) + λ d ( {f}_{{θ}^{*}} ( x , y ) , {f}_{{θ}^{︶}} ( x , y ) ) \qquad ( 4 )$$

In a second example, T is the distortion between the quantized model's prediction ƒ_{θ̆}(x,y) and the unquantized model's prediction ƒ_{θ}(x,y) at current iteration. Said otherwise, T is the distortion between an image reconstructed from the neural network INR parametrized with dequantized weights θ̆ and an image reconstructed from the neural network INR parametrized with unquantized weights θ. Thus, during the training, the following loss function is minimized:

$$Loss = \frac{1}{M N} {\sum }_{x , y} d ( I ( x , y ) , {f}_{{θ}^{︶}} ( x , y ) ) + λ d ( {f}_{θ} ( x , y ) , {f}_{{θ}^{︶}} ( x , y ) ) \qquad ( 5 )$$

Using a regularization term T in the training has at least two advantages. First, it smooths the noise in the gradients introduced by the quantization during forward pass. In the neural network literature, the forward pass designates the flow direction from “input” to “output”. The backward pass designates the flow direction from “output” to “input”, hereinafter gradients are propagated backwards.

Second, in the case where the quantized model ƒ_{θ̆}(x,y) could not converge to the high frequency components in the original image, at least it tries to converge to the full-precision model's prediction ƒ_{θ*}(x,y) which has less higher frequency component than the original image. This regularization term thus helps the optimization especially for higher quality.

In order to have a faster encoding it is sufficient to minimize only the regularization term in equation (4), i.e. d(ƒ_{θ*}(x,y), ƒ_{θ̆}(x,y)). The hyperparameter λ may be chosen once and used for a whole dataset, or it may be tuned according to a specific image. During encoding, the training may be performed in multiple devices for each hyperparameter of a set of hyperparameters, e.g. using the faster encoding, rather than encoding on a single device. The weights corresponding to the lower loss are the ones that are quantized and encoded. Having an image specific hyperparameter λ results in better performance.

During the backward pass, as the nature of quantization is non-differentiable, the gradients are computed using straight-through-estimator (STE), and weights are updated with any optimizers. Finally, once determined, the weights (tensor values and/or bias) are quantized to q-bits and encoded. To this aim, as in the previous embodiment, the steps S110 to S130 apply on the weights obtained by the above training method. Thus, a maximum absolute value is determined per layer and per type of weights (tensor, bias, etc). The weights obtained by the above training method are quantized responsive to the obtained maximum absolute value(s). The obtained maximum absolute value(s) are encoded using n bits, e.g. n=16 bits, and the quantized weights θ are encoded, e.g. by an entropy encoder.

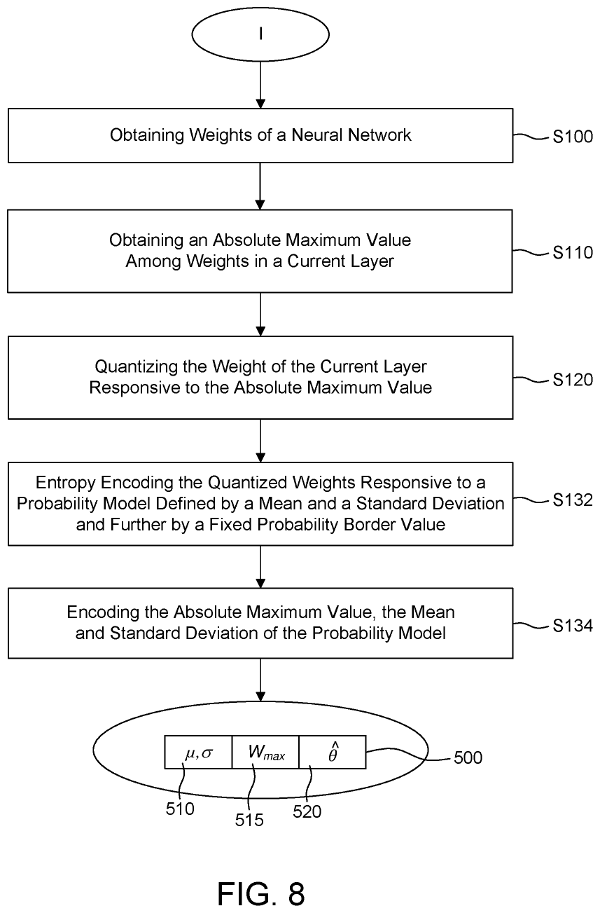

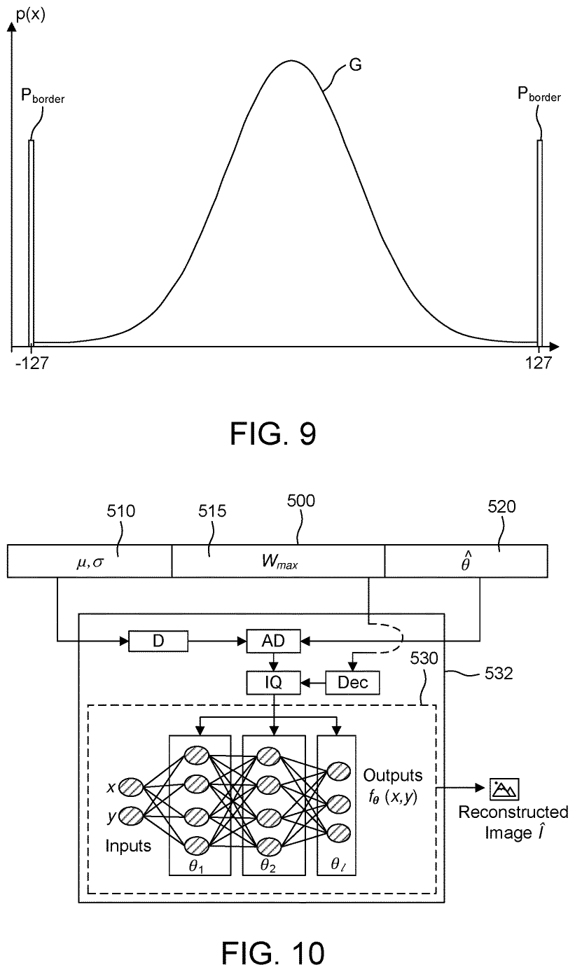

FIG. 8 illustrates an example of flowchart of a method for encoding an image I according to another embodiment. This method may be operated by the encoder 312 of FIG. 3 and for example implemented in the system 100 of FIG. 1. The steps identical to the steps of the encoding method depicted on FIG. 4 are identified on FIG. 9 with the same numeral references. In particular, the method comprises the steps S100, S110 and S120. As explained with reference to the previous embodiments, at step S130, the quantized weights may be directly written in the bitstream using q bits. However, they may also be encoded using various methods, e.g. entropy encoding method and more particularly arithmetic encoding method to gain additional compression efficiency. The entropy encoding may take advantage of the weight distribution shape, and model the q-bit quantized weights \hat{θ}=[\hat{θ}_{w}, \hat{θ}_{b}] to follow explicit univariate probability distribution, that is a fixed probability P_{border} for the border values (it is −127 and +127 for 8-bit quantization or more generally −(2^{q-1}−1) and +(2^{q-1}−1) for q-bits quantization) and gaussian distribution G for the rest of the symbols as illustrated on FIG. 9. Indeed, in every layer, there is at least one symbol whose value is the maximum absolute (either positive or negative). This symbol can be either −127 or +127 in case of 8-bit quantization and their probabilities cannot fit any gaussian distribution well. Since there are |\hat{θ}|=|\hat{θ}_{w}|+|\hat{θ}_{b}| number of weights to be encoded and at least L out of |\hat{θ}_{w}| tensor values and L out of |\hat{θ}_{b}| biases that are quantized either −127 or +127 with a same probability, this same probability may thus be defined as follows P_{border}=p(−127)=p(127)=L/|\hat{θ}|. The remaining symbols may follow a truncated gaussian distribution with a support of [−126 +126] and total probability of 1−2L/|\hat{θ}|. The parameters of the gaussian distribution can be calculated by encoded symbols' statistics whose values are not −127 or +127. Thus, if the weights to be encoded whose value is not −127 or +127 is defined by θ̅=[θ∈\hat{θ}|126≥θ≥−126], the parameters of the gaussian distribution's mean μ=E(θ̅) and variance σ²=E(θ̅²)−E(θ̅)² may be estimated from θ̅. Thus, the probability of each symbol may be defined as follows in the case where N(.; μ, σ²) is the gaussian distribution with given parameters μ, σ².

$$p ( x ) = \{ \begin{matrix}( 1 - \frac{2 L}{\vert \hat{θ} \vert} ) \cdot \frac{N ( x ; μ , {σ}^{2} )}{{\sum }_{u = - 126}^{126} ( N ( u ; μ , {σ}^{2} ) )} & if 126 \geq x \geq - 126 \\ L / \vert \hat{θ} \vert & if x = - 127 or x = 127 \\ 0 & else\end{matrix}$$

At the step S132, the quantized weights are entropy encoded, e.g. by an arithmetic encoder, using the above probability distribution (also called probability model) defined as a truncated gaussian distribution (also called normal distribution) whose parameters are μ and σ² and further defined by the fixed probability border value P_{border}.

The rate (expected bit-length) of \hat{θ} can be computed as follows:

$$R = - {\sum }_{i} {log}_{2} p ( {\hat{θ}}_{i} )$$

In this embodiment, at step S134, in addition to the maximum absolute value(s) of weight(s) and the quantized weights \hat{θ}, the mean μ and variance σ² or standard deviation σ of the gaussian distribution are also encoded, e.g. using 16 bits floating point each, in a bitstream such as the bitstream 500.

In another embodiment, different values L₁/|\hat{θ}| and 2L−L₁/|\hat{θ}| may be used to define the probabilities for the border values. In that case, L₁ may be encoded in the bitstream

The probabilities of the border values may also include a term from the Gaussian distribution as defined below:

$$p ( x ) = \{ \begin{matrix}( 1 - \frac{2 L}{\vert \hat{θ} \vert} ) \cdot \frac{N ( x ; μ , {σ}^{2} )}{{\sum }_{u = - 127}^{127} ( N ( u ; μ , {σ}^{2} ) )} & if 126 \geq x \geq - 126 \\ \frac{L}{\vert \hat{θ} \vert} + ( 1 - \frac{2 L}{\vert \hat{θ} \vert} ) \cdot \frac{N ( x ; μ , {σ}^{2} )}{{\sum }_{u = - 127}^{127} ( N ( u ; μ , {σ}^{2} ) )} & if x = - 127 or x = 127 \\ 0 & else\end{matrix}$$

The probabilities of the border values may be defined as a fixed value, other than L/|\hat{θ}|. In case where the data are adapted per image, additional information may be included in the bitstream, e.g., L₁ or one or more bits signaling the choice made for each image.

FIG. 10 illustrates an example of an image decoder 532 according to at least one embodiment. This decoder 532 is for example implemented in the system 100 of FIG. 1 and is adapted to decode encoded data, for example arranged as a bitstream 500, comprising entropy model parameters 510 mean μ and standard deviation σ (or variance σ²), encoded maximum absolute value(s) 515 and encoded quantized weights 520. The encoded maximum absolute value(s) are decoded dec from the bitstream. The parameters of the entropy model are decoded D. The encoded quantized weights 520 are entropy decoded by an entropy decoder AD whose probability model is parametrized by the parameters μ and σ² and further by the fixed probability border value P_{border}. The decoded quantized weights are inverse quantized (also called dequantized) responsive to the decoded maximum absolute value(s). The pixel coordinates of the image to be reconstructed are then inputted into the INR 530 parametrized by the dequantized weights to obtain a reconstructed image I.

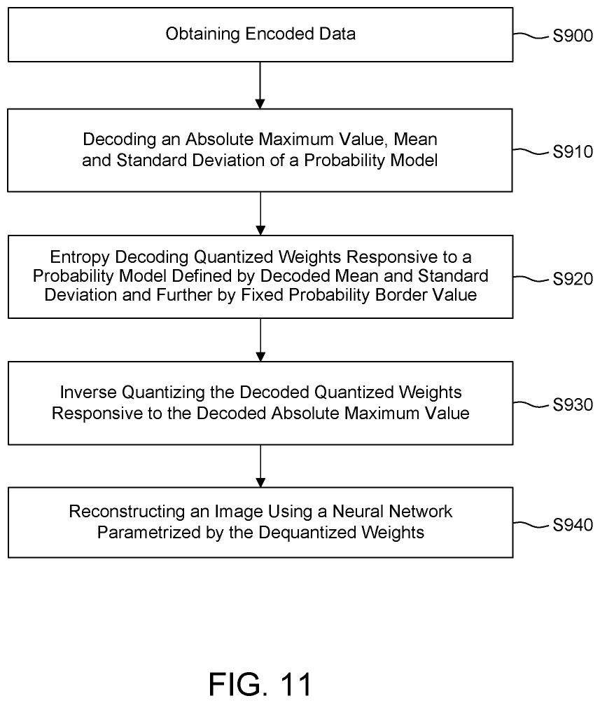

FIG. 11 illustrates an example of flowchart of a method for decoding according to an embodiment. This method may be operated by the decoder 332 of FIG. 3 or 532 of FIG. 10 and for example implemented in the system 100 of FIG. 1.

In a step S900, the decoder obtains encoded data, e.g. in the form of a bitstream, received from another device or read from a storage medium. The encoded data comprises at least one maximum absolute value(s) wₘₐₓ, quantized weights \hat{θ}, a mean μ and a standard deviation u (or the variance σ²) of a probability model for example as depicted on FIG. 9.

In a step S910, the mean μ and standard deviation σ (or variance σ²) and the at least one maximum absolute value wₘₐₓ are decoded from the bitstream.

In a step S920, the quantized weights that were entropy encoded are entropy decoded using the probability model defined as a truncated Gaussian distribution whose parameters are μ and σ² and further defined by the fixed probability border value P_{border}. This step is the inverse of the entropy encoding step.

In a step S930, the decoded quantized weights are inverse quantized responsive to the decoded maximum absolute value. As an example, for a current layer l and for a tensor value, the dequantized weight is obtained as follows:

$${Q}^{- 1} ( {\hat{θ}}_{{w}^{l}} ) = \frac{{\hat{θ}}_{{w}^{l}}}{k} {w}_{m ax}^{l} .$$

The same principle may apply to all layers and all types of weights, e.g. the bias, or a subset of them depending on what was encoded.

In a step S940, the pixel coordinates of the image to be reconstructed are then inputted into the INR 330 parametrized by the dequantized weights to obtain the reconstructed image I.

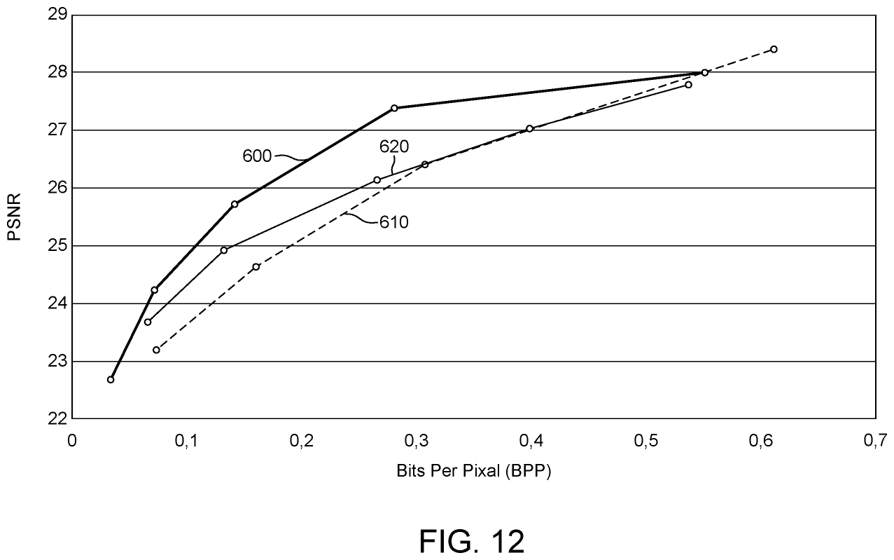

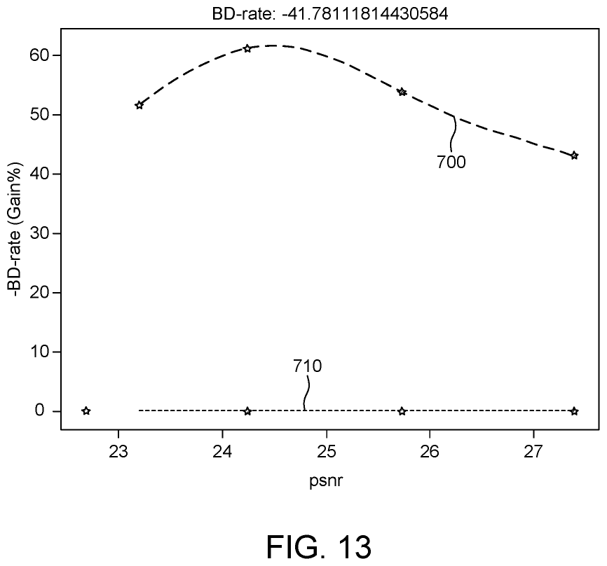

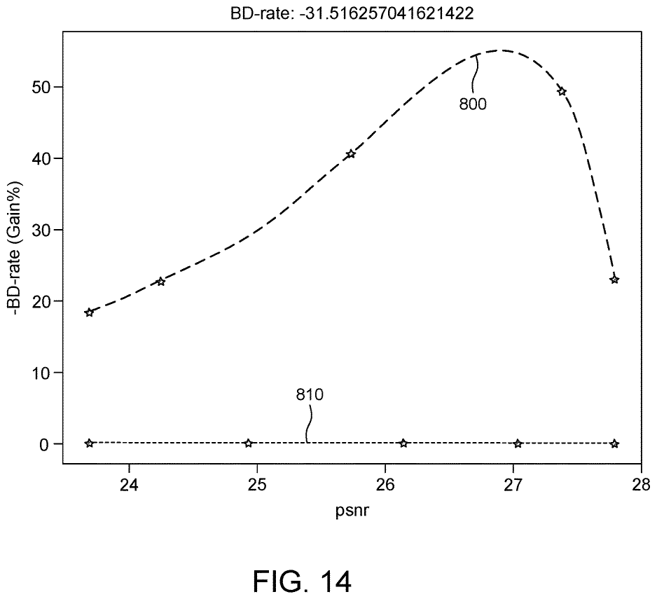

The following figures illustrate experimental results of obtained with the above method (with quantization, entropy coding, and quantization aware training) on the Kodak Test Set. FIG. 12 shows a rate distortion curve averaged over all the images in the Kodak dataset and shows that the proposed method 600 has a significant gain over the competitors, known as coin 610 and coin++ 620. To quantify the gain in %, the BD rate gain is computed. FIG. 13 shows an average gain of the disclosed method 700 of 41.8% over the coin method 710 and FIG. 14 shows an average gain of the disclosed method 800 of 31.5% over the coin++ 810. The regularization term T brings about 10% gain over just using 8-bit quantization with entropy coding. In addition, the methods disclosed are generic and can be applied up to any INR based image/video codecs.

Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding,” as used in this application, may encompass all or part of the processes performed, for example, on a received encoded sequence in order to produce a final output suitable for display. In various embodiments, such processes include one or more of the processes typically performed by a decoder, for example, entropy decoding and inverse quantization. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application may encompass all or part of the processes performed, for example, on an input video sequence in order to produce an encoded bitstream.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, mean that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout the specification are not necessarily all referring to the same embodiment.

Additionally, this application or its claims may refer to “determining” various pieces of information. Determining the information may include one or more of, for example, estimating the information, calculating the information, predicting the information, or retrieving the information from memory.

Further, this application or its claims may refer to “accessing” various pieces of information. Accessing the information may include one or more of, for example, receiving the information, retrieving the information (for example, from memory), storing the information, moving the information, copying the information, calculating the information, predicting the information, or estimating the information.

Additionally, this application or its claims may refer to “receiving” various pieces of information. Receiving is, as with “accessing”, intended to be a broad term. Receiving the information may include one or more of, for example, accessing the information, or retrieving the information (for example, from memory or optical media storage). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Also, as used herein, the word “signal” refers to, among other things, indicating something to a corresponding decoder. For example, in certain embodiments the encoder signals a quantization matrix for de-quantization, or at least one value representative of a maximum absolute value of weights in a layer of said neural network, quantize weights, mean and standard deviation of a gaussian distribution. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of embodiments has been described above. Features of these embodiments can be provided alone or in any combination, across various claim categories and types.

An encoding method is disclosed that comprises:
obtaining weights of a neural network, said weights being representative of an input image;
obtaining at least one value representative of a maximum absolute value of weights in a layer of said neural network;
quantizing the weights of said layer responsive to said at least one value; and
encoding said at least one value and the quantized weights in a bitstream.

In an example, quantizing the weights of said layer responsive to said at least one value comprises:
dividing the weights by the at least one value to obtain normalized weights; and
quantizing the normalized weights using a fixed-bit quantizer.

In an example, encoding the quantized weights comprises entropy coding the quantized weights using a probability model defined by a fixed probability for border symbol values and a gaussian distribution for remaining symbols.

In an example, a mean and a standard deviation of said gaussian distribution are encoded in the bitstream.

In an example, obtaining weights of a neural network comprises minimizing a distortion between the input image and an image reconstructed from a neural network parametrized by dequantized weights.

In an example, obtaining weights of a neural network comprises minimizing a loss function being a weighted sum between a first a distortion and a second distortion, wherein the first distortion is a distortion between the input image and an image reconstructed from the neural network parametrized by dequantized weights and the second distortion is a distortion between an image reconstructed from the neural network parametrized by fixed weights with a full precision and an image reconstructed from the neural network parametrized by dequantized weights.

In an example, obtaining weights of a neural network comprises minimizing a loss function being a weighted sum between a first a distortion and a second distortion, wherein the first distortion is a distortion between the input image and an image reconstructed from the neural network parametrized by dequantized weights and the second distortion is a distortion between an image reconstructed from the neural network parametrized by non-quantized weights and an image reconstructed from the neural network parametrized by dequantized weights.

In an example, weights belong to a set of weights comprising a bias and a tensor value.

A decoding method is disclosed that comprises:
obtaining a bitstream comprising at least one value representative of a maximum absolute value of weights in a layer of a neural network and quantized weights of said layer;
decoding said at least one value and said quantized weights of a neural network from the bitstream;
inverse quantizing the quantized weights of said layer responsive to the at least one value to obtain dequantized weights; and
reconstructing an image using a neural network parametrized by the dequantized weights.

In an example, inverse quantizing the weights of said layer responsive to said at least one value comprises:
inverse quantizing the quantized weights using a fixed-bit quantizer; and
multiplying the inverse quantized weights with the at least one value to obtain dequantized weights.

In an example, decoding the quantized weights comprises entropy decoding the quantized weights using a probability model defined by a fixed probability for border symbol values and a gaussian distribution for remaining symbols.

In an example, a mean and a standard deviation of said gaussian distribution are decoded from the bitstream.

In an example, said weights belong to a set of weights comprising a bias and a tensor value.

An encoding apparatus is disclosed that comprises one or more processors and at least one memory coupled to said one or more processors, wherein said one or more processors are configured to perform the encoding method according to any one of the examples previously disclosed.

A decoding apparatus is disclosed that comprises one or more processors and at least one memory coupled to said one or more processors, wherein said one or more processors are configured to perform the decoding method according to any one of the examples previously disclosed.

A computer program is disclosed that comprises program code instructions for implementing the encoding or decoding methods when executed by a processor.

A computer readable storage medium is disclosed that has stored thereon instructions for implementing the encoding or decoding methods.

1. An encoding method comprising:
obtaining weights of an implicit neural network (INR), the INR taking as input coordinates of pixels of an input image and output intensity values of the pixels;
obtaining at least one value representative of a maximum absolute value of weights in a layer of the INR;
quantizing the weights of the layer responsive to the at least one value; and
encoding the at least one value and the quantized weights in a bitstream, wherein encoding the quantized weights comprises entropy coding the quantized weights using a probability model defined by a fixed probability for border symbol values and a truncated gaussian distribution for remaining symbols.

2. The method of claim 1, wherein quantizing the weights of the layer responsive to the at least one value comprises:
dividing the weights by the at least one value to obtain normalized weights; and
quantizing the normalized weights using a fixed-bit quantizer.

3. (canceled)

4. The method of claim 1, wherein a mean and a standard deviation of the truncated gaussian distribution are encoded in the bitstream.

5. The method of claim 1, wherein obtaining weights of the implicit neural network comprises minimizing a distortion between the input image and an image reconstructed from the INR parametrized by dequantized weights.

6. The method of claim 1, wherein obtaining weights of the implicit neural network comprises minimizing a loss function being a weighted sum between a first a distortion and a second distortion, wherein the first distortion is a distortion between the input image and an image reconstructed from the INR parametrized by dequantized weights and the second distortion is a distortion between an image reconstructed from the INR parametrized by fixed weights with a full precision and an image reconstructed from the neural network parametrized by dequantized weights.

7. The method of claim 1, wherein obtaining weights of the implicit neural network comprises minimizing a loss function being a weighted sum between a first a distortion and a second distortion, wherein the first distortion is a distortion between the input image and an image reconstructed from the neural network parametrized by dequantized weights and the second distortion is a distortion between an image reconstructed from the INR parametrized by non-quantized weights and an image reconstructed from the INR parametrized by dequantized weights.

8. (canceled)

9. A decoding method comprising:
obtaining a bitstream comprising at least one value representative of a maximum absolute value of weights in a layer of an implicit neural network (INR) and quantized weights of the layer;
decoding the at least one value and the quantized weights of a neural network from the bitstream, wherein decoding the quantized weights comprises entropy decoding the quantized weights using a probability model defined by a fixed probability for border symbol values and a truncated gaussian distribution for remaining symbols;
inverse quantizing the quantized weights of the layer responsive to the at least one value to obtain dequantized weights; and
reconstructing an image using an INR parametrized by the dequantized weights, the INR taking as input coordinates of pixels of an input image and output intensity values of the pixels.

10. The method of claim 9, wherein inverse quantizing the weights of the layer responsive to the at least one value comprises:
inverse quantizing the quantized weights using a fixed-bit quantizer; and
multiplying the inverse quantized weights with the at least one value to obtain dequantized weights.

11. (canceled)

12. The method of claim 9, wherein a mean and a standard deviation of the truncated gaussian distribution are decoded from the bitstream.

13. (canceled)

14. An encoding apparatus comprising one or more processors and at least one memory coupled to the one or more processors, wherein the one or more processors are configured to perform:
obtaining weights of an implicit neural network (INR), the INR taking as input coordinates of pixels of an input image and output intensity values of the pixels;
obtaining at least one value representative of a maximum absolute value of weights in a layer of the INR;
quantizing the weights of the layer responsive to the at least one value; and
encoding the at least one value and the quantized weights in a bitstream, wherein encoding the quantized weights comprises entropy coding the quantized weights using a probability model defined by a fixed probability for border symbol values and a truncated gaussian distribution for remaining symbols.

15. A decoding apparatus comprising one or more processors and at least one memory coupled to the one or more processors, wherein the one or more processors are configured to perform:
obtaining a bitstream comprising at least one value representative of a maximum absolute value of weights in a layer of an implicit neural network (INR) and quantized weights of the layer;
decoding the at least one value and the quantized weights of a neural network from the bitstream, wherein decoding the quantized weights comprises entropy decoding the quantized weights using a probability model defined by a fixed probability for border symbol values and a truncated gaussian distribution for remaining symbols;
inverse quantizing the quantized weights of the layer responsive to the at least one value to obtain dequantized weights; and
reconstructing an image using an INR parametrized by the dequantized weights, the INR taking as input coordinates of pixels of an input image and output intensity values of the pixels.

16-17. (canceled)

18. The method of claim 1, wherein the fixed probability for border symbol values is equal to a number of layers divided by number of weights to be encoded and the truncated gaussian distribution has a total probability of one minus twice the fixed probability.

19. The method of claim 9, wherein the fixed probability for border symbol values is equal to a number of layers divided by number of weights to be decoded and the truncated gaussian distribution has a total probability of one minus twice the fixed probability.

20. The encoding apparatus of claim 14, wherein quantizing the weights of the layer responsive to the at least one value comprises:
dividing the weights by the at least one value to obtain normalized weights; and
quantizing the normalized weights using a fixed-bit quantizer.

21. The encoding apparatus of claim 14, wherein the fixed probability for border symbol values is equal to a number of layers divided by number of weights to be encoded and the truncated gaussian distribution has a total probability of one minus twice the fixed probability.

22. The encoding apparatus of claim 14, wherein a mean and a standard deviation of the truncated gaussian distribution are encoded in the bitstream.

23. The decoding apparatus of claim 15, wherein inverse quantizing the weights of the layer responsive to the at least one value comprises:
inverse quantizing the quantized weights using a fixed-bit quantizer; and
multiplying the inverse quantized weights with the at least one value to obtain dequantized weights.

24. The decoding apparatus of claim 15, wherein the fixed probability for border symbol values is equal to a number of layers divided by number of weights to be decoded and the truncated gaussian distribution has a total probability of one minus twice the fixed probability.

25. The decoding apparatus of claim 15, wherein a mean and a standard deviation of the truncated gaussian distribution are decoded from the bitstream.
